(19) United States
(12) Patent Application Publication
(10) Pub. No.: US 2017/0038904 A1
(43) Pub. Date: Feb. 9, 2017

(54) INPUT DEVICE

(71) Applicant: Sharp Kabushiki Kaisha, Osaka (JP)

(72) Inventor: Tetsuo MURATA, Osaka (JP)

(73) Assignee: Sharp Kabushiki Kaisha, Osaka (JP)

(21) Appl. No.: 15/305,200

(22) PCT Filed: Apr. 16, 2015
(86) PCT No.: PCT/JP2015/061657

§ 371 Date: Oct. 19, 2016

(30) Foreign Application Priority Data
Apr. 23, 2014 (JP) 2014-089061

(51) Int. Cl. G06F 3/041; G06F 3/01; G06F 3/0488; G06F 3/044

(52) U.S. Cl. CPC G06F 3/0416; G06F 3/044; G06F 3/016; G06F 3/0412; G06F 3/04886

(57) ABSTRACT

An input device includes a display unit having a display screen on which a plurality of buttons are displayed and a touch panel that detects a location on the display screen that has been touched, a vibration unit that causes the display unit to vibrate, an input controller that validates an input based on touch when the location detected by the touch panel is within a button, and a vibration controller that does not cause the vibration unit to vibrate when the location detected by the touch panel is confined to only one button, but causes the vibration unit to continually vibrate when another location is detected for as long as the other location is being detected.

### TECHNICAL FIELD

The present invention relates to an input device.

### BACKGROUND ART

Conventionally, in an input device having a display screen where a plurality of valid regions such as buttons that validate input from a user and a touch panel for detecting the location on the screen that has been touched, the display screen is caused to vibrate when a prescribed location on the display screen has been touched. Patent Document 1, for example, discloses an input controller that, when a plurality of buttons are displayed on a display screen, causes the touch panel to momentarily vibrate when it is unclear that the location on the display screen touched by the user is an appropriate location, or more specifically, when a location not corresponding to a button on the display screen has been touched.

### RELATED ART DOCUMENT

### Patent Document

Patent Document 1: Japanese Patent Application Laid-Open Publication No. 2005-190290

### Problems to be Solved by the Invention

Recently, input devices equipped with touch panels have been adopted in car-mounted air conditioners, car-mounted navigation systems, and the like. In these types of input devices, the user performs input while driving, and thus the user often touches the touch panel without looking at the display screen. However, when the user touches the touch panel in this manner without looking at the display screen, if the vibration of the touch panel is momentary as described for the input controller of Patent Document 1, then there is a risk that the user who has touched a location not corresponding to a button on the display screen will not be able to sense the vibration and will not be recognize whether the desired button has been touched.

### SUMMARY OF THE INVENTION

The technology described in the present specification was made in view of the above-mentioned problems and aims at guiding a user to a desired valid region on the display screen when it is unclear whether the location touched by the user on the display screen is a valid location.

### Means for Solving the Problems

The technology described in the present specification relates to an input device, including: a display unit having a display screen on which a plurality of valid regions are displayed and a touch detection unit that detects a location on the display screen that has been touched; a vibration unit that vibrates the display unit; an input controller that validates an input from the touch when the location detected by the touch detection unit is within the valid regions; and a vibration controller that does not cause the vibration unit to operate when the location detected by the touch detection unit fits within only one of the valid regions, but causes the vibration unit to continually operate when another location is detected for as long as the another location is being detected.

If the touch location of the user does not fit within only one valid region, then it is unclear which valid region the user desires to touch, and thus improper to judge such a location as an appropriate location for the touch location of the user. In the input device described above, if the touch location of the user is a location that fits within only one valid region, then the display unit does not vibrate, but for other locations the vibration unit continually vibrates the display unit for as long as the other locations are being detected; therefore, the user can recognize a location that fits into only one valid region by shifting the touch location until the vibrating stops.

Accordingly, even if the display screen does not have recesses, protrusions, or the like for indicating the location of the valid regions, or namely, even if the display screen is a flat surface, the user can arrive at the desired valid region by shifting the touch location in accordance with the pre-stored arrangement of valid regions. In this manner, in the input device described above, a simple configuration that does not require processing or the like of the display screen makes it possible to guide the user to the desired valid region on the display screen when it is unclear whether the touch location of the user on the display screen is an appropriate location.

When the location detected by the touch detection unit includes a location outside the valid regions, the vibration controller may cause the vibration unit to continually operate for as long as the location is being detected.

If a plurality of regions are displayed on the display screen with gaps therebetween, it is difficult to determine which valid region the user wants to touch if the touch location of the user is outside the valid region. With the above-mentioned configuration, if the touch location includes a location outside the valid region, the display unit continually vibrates during the touching of this touch location, and thus even if a plurality of valid regions are displayed with gaps therebetween, the user can be guided to the desired valid region on the display screen by shifting the touch location until the vibrating stops. A “location that includes a location outside the value region” refers both to a location only outside the valid region and a location that straddles the inside of the valid region and outside of the valid region.

The plurality of valid regions may be displayed on the display screen with each valid region abutting at least one other valid region, and when the location detected by the touch detection unit includes a location within two or more of the valid regions, the vibration controller may cause the vibration unit to continually operate for as long as the location is being detected.

If a plurality of valid regions are displayed on the display screen with each valid region abutting at least one other valid region, it is difficult to determine which valid region the user wants to touch if the touch location of the user includes a location within two or more valid regions. With the above-mentioned configuration, if the touch location of the user includes a location within two or more valid regions, the display unit continually vibrates during the touching of this touch location, and thus even if the plurality of valid regions are displayed abutting each other, the user can be guided to the desired valid regions on the display screen by shifting the touch location until the vibrating stops.

The plurality of valid regions may be equal in size and shape to one another, and may be displayed on the display screen in a matrix pattern.

With this configuration, when it is unclear if the touch location of the user on the display screen is an appropriate location, the user can shift the touch location on the display screen in either the vertical or horizontal direction on the display screen in order to arrive at the desired valid region. Thus, in the above-mentioned configuration, it is possible to easily guide the user to the desired valid region on the display screen as compared to if the size, shape, etc. of the valid regions differed from each other or if the valid regions were displayed in an irregular arrangement.

The technology described in the present specification can be achieved via various types of aspects such as a computer program for realizing the functions of the input device, a storage medium for storing this computer program, or the like.

### Effects of the Invention

The technology described in the present specification makes it possible to guide a user to a desired valid region on the display screen when it is unclear whether a location touched by the user on the display screen is a valid location.

### BRIEF DESCRIPTION OF THE DRAWINGS

FIG. 1 is a plan view of an input device according to Embodiment 1.

FIG. 2 is a cross-sectional view showing a schematic configuration of the input device.

FIG. 3 is a cross-sectional view of a liquid crystal panel, touch panel, and cover panel.

FIG. 4 is a plan view of the liquid crystal panel connected to a flexible substrate for the panel.

FIG. 5 is a plan view of the touch panel.

FIG. 6 is a plan view of a planar configuration of the touch panel pattern.

FIG. 7 is a block diagram showing the electrical configuration of the input device.

FIG. 8 is a flow chart showing a vibration control process executed by a CPU in the input device.

FIG. 9 is a plan view of a display aspect of each button displayed on the display screen.

FIG. 10 is a plan view of a state in which a portion of the display screen has been touched.

FIG. 11 is a plan view of a state in which a portion of the display screen has been touched.

FIG. 12 is a plan view of a state in which a portion of the display screen has been touched.

FIG. 13 is a plan view showing touch example 1 on the display screen.

FIG. 14 is a plan view showing touch example 1 on the display screen.

FIG. 15 is a plan view showing touch example 2 on the display screen.

FIG. 16 is a plan view showing touch example 2 on the display screen.

FIG. 17 is a plan view of a detection scheme for touch location in Embodiment 2.

FIG. 18 is a flow chart showing a vibration control process executed by a CPU in an input device in Embodiment 2.

FIG. 19 is a plan view of a display aspect of each button displayed on the display screen in Embodiment 2.

FIG. 20 is a plan view of a state in which a portion of the display screen has been touched in Embodiment 2.

FIG. 21 is a plan view of a state in which a portion of the display screen has been touched in Embodiment 2.

FIG. 22 is a plan view of a state in which a portion of the display screen has been touched in Embodiment 2.

FIG. 23 is a plan view of a display aspect of each button displayed on a display screen in Embodiment 3.

FIG. 24 is a plan view of a display aspect of each button displayed on a display screen in a modification example.

FIG. 25 is a plan view of a display aspect of each button displayed on a display screen in a modification example.

FIG. 26 is a plan view of a display aspect of each button displayed on a display screen in a modification example.

### DETAILED DESCRIPTION OF EMBODIMENTS

### Embodiment 1

### Appearance Configuration of Input Device

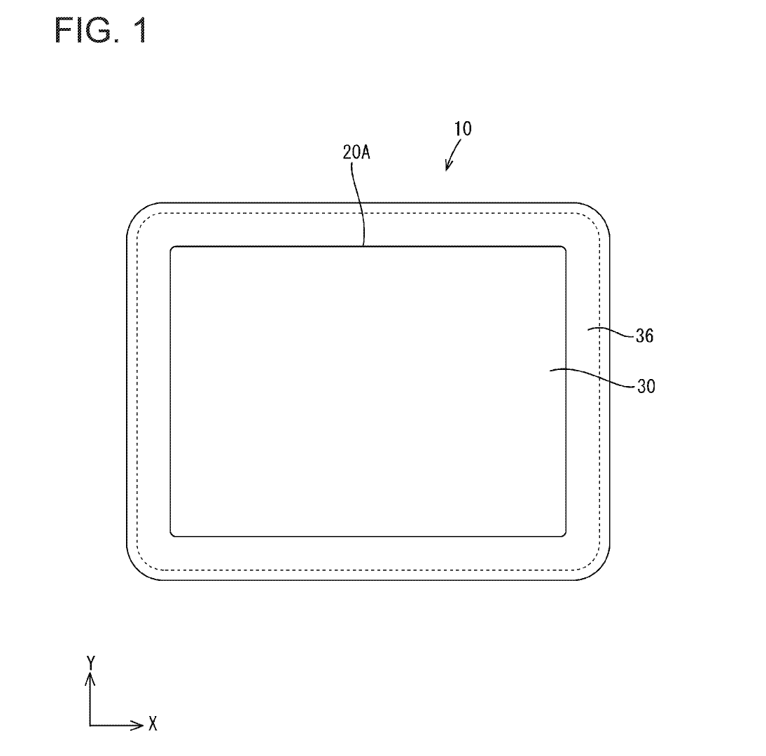

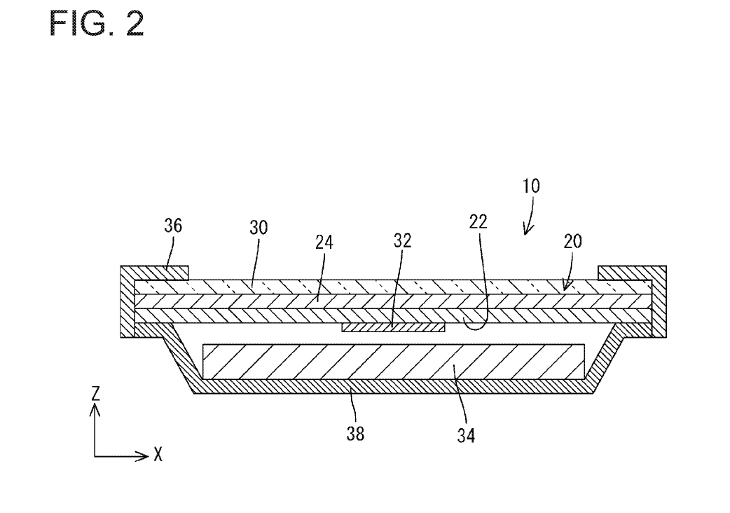

Embodiment 1 will be explained with reference to FIGS. 1 to 16. In the present embodiment, an input device 10 is illustratively shown in FIG. 1. Each of the drawings indicates an X axis, a Y axis, and a Z axis in a portion of the drawings, and each of the axes indicates the same direction for the respective drawings. The up and down direction in the drawings is based on the up and down direction in FIG. 2, and the upper side in FIG. 2 is referred to as the front side while the lower side thereof is referred to as the rear side.

First, the configuration of the input device 10 will be explained. As shown in FIG. 1, the input device 10 has a box shape in a plan view and is used in a horizontal orientation. As shown in FIG. 2, the input device 10 includes a display unit 20 that displays an image on a flat display screen 20A (see FIG. 1) and that has a function for detecting a touched location on the display screen 20A, a cover panel 30 that protects the display screen 20A side of the display unit 20, a vibration unit 32 that has a function for causing the display unit 20 and the cover panel 30 to vibrate, and a backlight device 34, which is a light source that emits light towards the display unit 20. The input device 10 further includes a bezel 36 that holds the display unit 20 and cover panel 30, and a case 38 to which the bezel 36 is attached and that houses the backlight device 34.

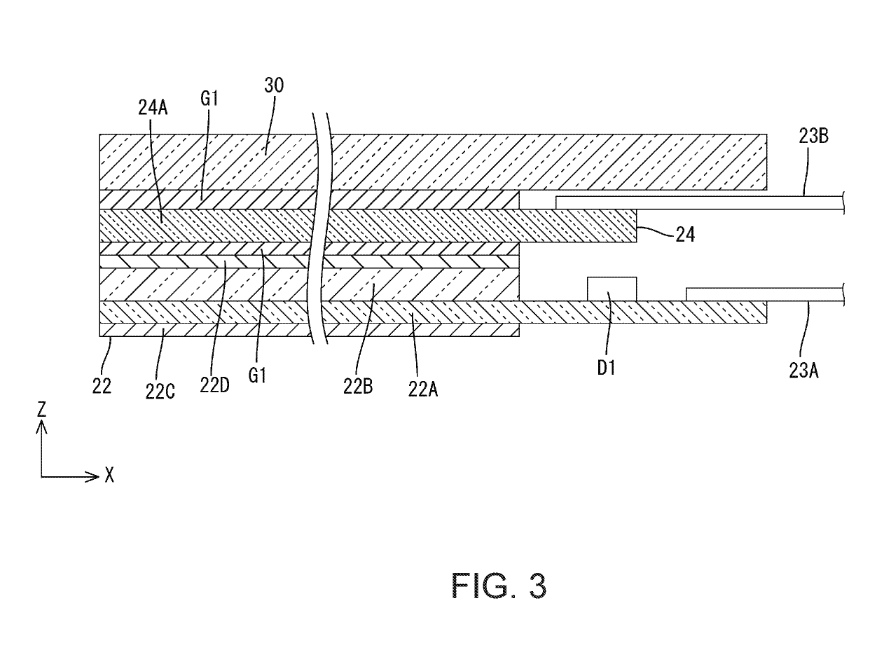

The display unit 20 includes a liquid crystal panel 22 that displays images on the display screen 20A, and a touch panel 24 that has a function for detecting a location on the display screen 20A that has been touched. As shown in FIG. 3, the liquid crystal panel 22 and touch panel 24 are each arranged such that primary surfaces thereof face each other with the touch panel 24 being located relatively towards the front and the liquid crystal panel 22 being located relatively towards the back, and a transparent photocurable adhesive G1 interposed therebetween adheres the liquid crystal panel 22 and the touch panel 24 together to form an integrated member. Furthermore, the cover panel 30 described above is adhered to the front surface of the touch panel 24 via the same transparent photocurable resin G1. The input device 10 of the present embodiment is used in car-mounted navigation systems and the like. Therefore, the size of the liquid crystal panel 22 forming a part of the input device 10 is approximately a few dozen inches, for example, and is generally classified as small or medium sized.

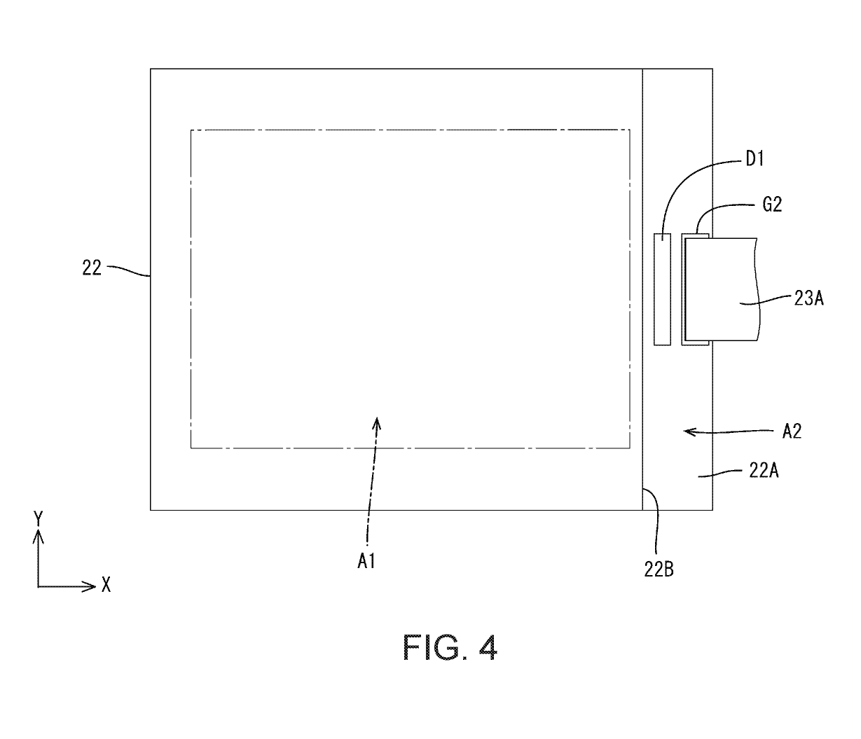

The liquid crystal panel 22 will be described next. As shown in FIGS. 3 and 4, the liquid crystal panel 22 includes a pair of transparent (having light-transmissive qualities) glass substrates 22A and 22B having a box shape, and a liquid crystal layer (not shown) including liquid crystal molecules interposed between the substrates 22A and 22B, and the substrates 22A and 22B are bonded together by a sealing member (not shown) maintaining a gap at a width equal to the thickness of the liquid crystal layer. As shown in FIG. 4, the liquid crystal panel 22 has a display area A1 (the area surrounded by the dashed line in FIG. 4) where images are displayed and a substantially frame-shaped non-display area A2 surrounding the display area A1 where images are not displayed. Furthermore, as shown in FIG. 3, the outer surfaces of the substrates 22A and 22B have polarizing plates 22C and 22D attached thereto. Of the front and rear polarizing plates 22C and 22D, the photocurable adhesive G1 is provided on almost the entire outer surface of the polarizing plate 22D on the front side, or namely the surface of the polarizing plate 22D facing the touch panel 24.

Of the two substrates 22A, 22B that form part of the liquid crystal panel 22, the substrate on the rear side is the array substrate 22A and the surface on the front side is the CF substrate 22B. The display area A1 on the inner surface of the array substrate 22A (the surface facing the CF substrate 22B) forming a portion of the liquid crystal panel 22 has aligned thereon a large number of TFTs (thin film transistors) as switching elements and pixel electrodes connected to the TFTs, and a large number of gate wiring lines and source wiring lines surround these TFTs and pixel electrodes and form a grid shape. The gate wiring lines and the source wiring lines are connected to the respective gate electrodes and source electrodes, and the pixel electrodes are connected to the drain electrodes of the TFTs.

Meanwhile, as shown in FIG. 4, in the non-display area A2 on the inner surface of the array substrate 22A, the gate wiring lines and the source wiring lines are lead out and a driver D1 for driving the liquid crystal is connected to the terminal section at the ends of the wiring lines. The driver D1 is mounted on one end in the lengthwise direction of the array substrate 22A via a COG (chip on glass) method and can supply driving signals to both types of wiring lines connected thereto. One end side of a first flexible substrate 23A is crimp connected via an anisotropic conductive film G2 to a location (non-display area A2) on the inner surface of the array substrate 22A adjacent to the driver D1. The other end of the first flexible substrate 23A connects to a control substrate (not shown) so as to be able to transmit image signals supplied from the control substrate to the driver D1.

The inner surface side of the CF substrate 22B (the surface facing the array substrate 22A) forming a portion of the liquid crystal panel 22 has aligned thereon a large number of color filters at locations overlapping the respective pixel electrodes of the array substrate 22A in a plan view. The color filters each have colored portions exhibiting R (red), G (green), and B (blue) in an alternating linear arrangement. A light-blocking member for preventing the mixing of colors is formed between the colored portions of the color filters. As shown in FIG. 4, the CF substrate 22B has smaller lengthwise (X axis direction) dimensions than the array substrate 22A and is bonded to the array substrate 22A such that, among both ends of the substrates in the lengthwise direction, the ends that are opposite to the side where the first flexible substrate 23A is arranged align with each other. Alignment films for aligning the liquid crystal molecules included in the liquid crystal layer are respectively formed on the inner surfaces of the substrates 22A and 22B.

The backlight device 34 will be briefly explained next. The backlight device 34 is a so-called edge-lit type and includes a light source, a substantially box-shaped chassis that has an opening in the front (the liquid crystal panel 22 side) and that houses the light source, a light guide member facing an end of the light source and guiding light from the light source so as to emit the light towards the opening in the chassis, and an optical member covering the opening in the chassis. The light emitted from the light source enters the edge of the light guide member, is propagated inside the light guide member, and then is emitted towards the opening of the chassis, after which it is converted into planar light having an even luminance distribution across a plane by the optical member, and then is emitted towards the liquid crystal panel 22.

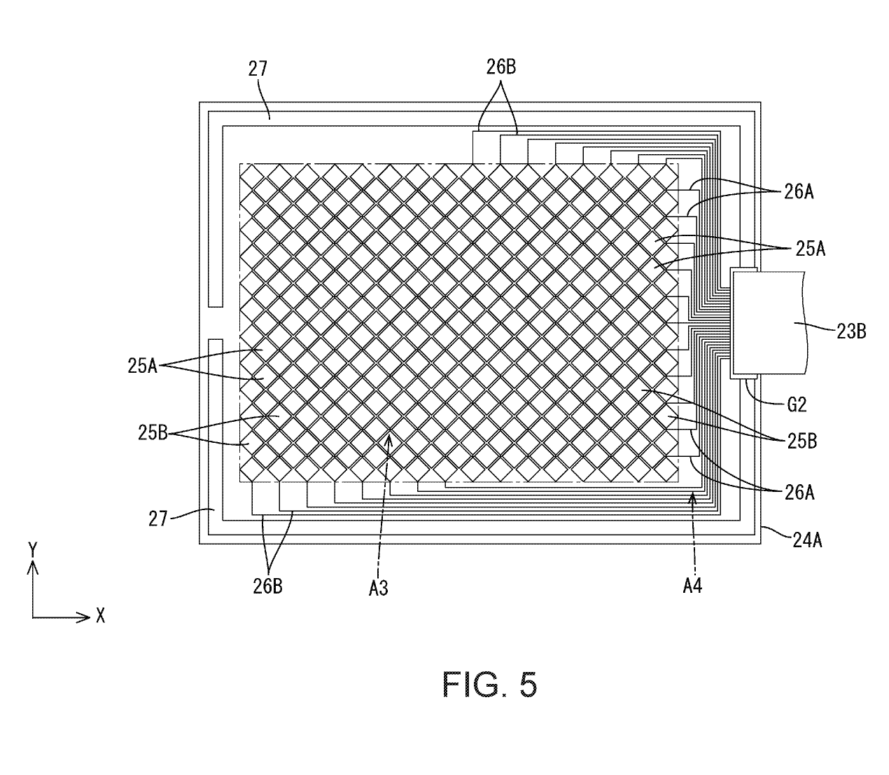

Next, the touch panel 24 will be described in detail. As shown in FIGS. 3 and 5, the touch panel 24 includes a transparent glass substrate 24A that is a rectangular shape in a plan view. As shown in FIG. 5, the touch panel 24 has a first overlapping area A3 that overlaps the display area A1 of the liquid crystal panel 22 in a plan view, and a second overlapping area A4 that overlaps the non-display area A2 of the liquid crystal panel in a plan view, and the second overlapping area A4 is substantially frame shaped and surrounds the first overlapping area A3. The touch panel 24 is approximately the same size as the liquid crystal panel 22 and is bonded to the liquid crystal panel 22 in parallel thereto by the photocurable adhesive G1. As shown in FIGS. 3 and 5, the glass substrate 24A of the touch panel 24 has approximately the same widthwise (Y axis direction) dimensions as the substrates 22A and 22B of the liquid crystal panel 22, with the lengthwise (X axis direction) dimensions being smaller than the array substrate 22A of the liquid crystal panel 22 and larger than the CF substrate 22B of the liquid crystal panel 22.

As shown in FIGS. 3 and 5, first transmissive electrodes 25A and second transmissive electrodes 25B are formed on the outer surface of the glass substrate 24A of the touch panel 24 (the surface opposite to the liquid crystal panel 22 side). The first transmissive electrodes 25A have extend in plurality of columns along the lengthwise (X axis direction) of the touch panel 24, and the second transmissive electrodes 25B extend in a plurality of columns along the widthwise (Y axis direction) of the touch panel 24. Both of the transmissive electrodes 25A and 25B are made of transmissive conductive materials that are almost transparent, such as ITO (indium tin oxide), and are arranged in the first overlapping area A3 on the touch panel 24. An insulating film is interposed between the transmissive electrodes 25A and 25B, and the first transmissive electrodes 25A and the second transmissive electrodes 25B are stacked in this order on the outer surface of the glass substrate 24A. The touch panel 24 of the present embodiment is a so-called projected capacitance scheme having a one-side stacked structure in which both of the transmissive electrodes 25A and 25B are stacked on the glass substrate 24A, and the change in surface charge at the touched location in the electric field formed by the transmissive electrodes 25A and 25B is ascertained in order to detect the location that was touched.

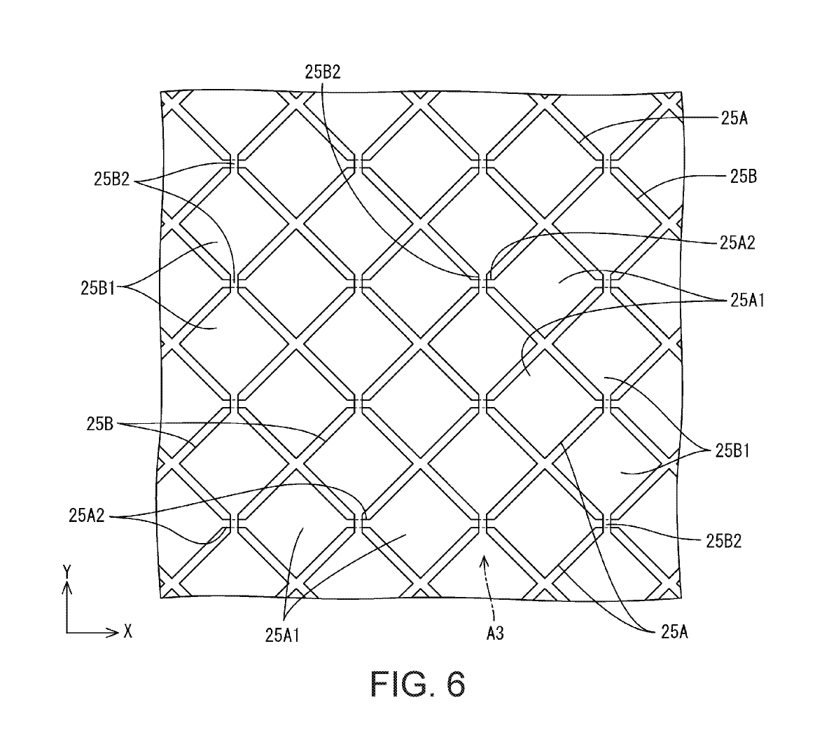

As shown in FIG. 6, the first transmissive electrodes 25A are constituted by a plurality of first electrode pads 25A1 having a diamond shape in a plan view and arranged in parallel along the X axis direction, and first connecting sections 25A2 that connect the adjacent first electrode pads 25A1 together. The first transmissive electrodes 25A extending along the X axis direction are arranged in a plurality in parallel along the Y axis direction with prescribed gaps therebetween. In contrast, the second transmissive electrodes 25B are constituted by a plurality of second electrode pads 25B1 having a diamond shape in a plan view and arranged in parallel along the Y axis direction, and second connecting sections 25B2 that connect the adjacent second electrode pads 25B1 together. The second transmissive electrodes 25B extending along the Y axis direction are arranged in a plurality in parallel along the X axis direction with prescribed gaps therebetween. Accordingly, stacking the first transmissive electrodes 25A and second transmissive electrodes 25B forms a matrix in which the first electrode pads 25A1 forming the first transmissive electrodes 25A and the second electrode pads 25B1 forming the second transmissive electrodes 25B are arrayed in the X axis direction and Y axis direction (see FIGS. 5 and 6).

The glass substrate 24A further includes thereon first potential-supplying wiring lines 26A for supplying a potential to the first transmissive electrodes 25A, second potential-supplying wiring lines 26B that supply a potential to the second transmissive electrodes 25B, and a ground wiring line 27 that can shield the transmissive electrodes 25A & 25B and the potential-supplying wiring lines 26A & 26B. The potential-supplying wiring lines 26A & 26 and the ground wiring line 27 are all made of a light-blocking metal material such as copper or titanium and are arranged in the second overlapping area A4 on the touch panel 24. The ends of the potential-supplying wiring lines 26A & 26B and the ground wiring line 27 are arranged on one lengthwise end on the glass substrate 24A and the wiring lines are connected to the second flexible substrate 23B at this location, with this connection location acting as the terminal. The second flexible substrate 23B has one end side thereof that connects to the various terminals of both potential-supplying wiring lines 26A & 26B and ground wiring line 27 via the anisotropic conductive film G2, whereas the other end sides connect to the controller substrate described above (not shown), which makes it possible for the potential supplied from the controller substrate to be transmitted to both potential-supplying wiring lines 26 & 26B and the ground wiring line 27.

Next, the vibration unit 32 will be described. The vibration unit 32 is disposed on the rear surface of the liquid crystal panel 22 and includes a vibration motor. The vibration unit 32 switches between OFF and ON by the driving thereof being controlled by a motor controller 64 (described later). The vibration unit 32 continually vibrates when turned ON, and stops vibrating when turned OFF. The vibrating of the vibration unit 32 vibrates the entire display unit 20 (liquid crystal panel 22 & touch panel 24) and the cover panel 30 that protects the display screen 20A side of the display unit 20. The magnitude of the vibration of the vibration unit 32 is set to an amount that allows the user to easily sense the vibration while touching the display screen 20A of the display unit 20.

(Electrical Configuration of Input Device)

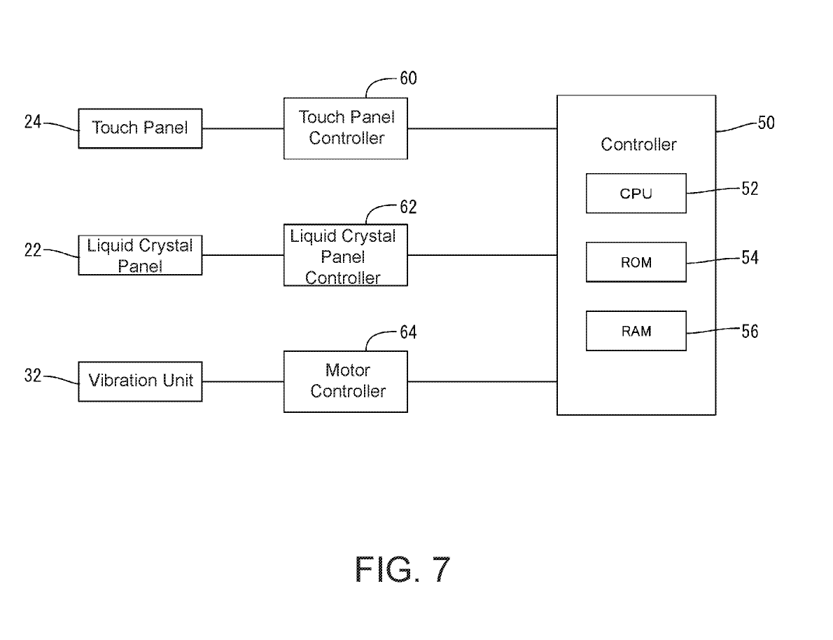

Next, an electrical configuration of the input device 10 will be explained. As shown in FIG. 7, the input device 10 further includes a controller 50, touch panel controller 60, liquid crystal panel controller 62, and motor controller 64. Of these, the controller 50 and motor controller 64 are included on the controller substrate described above; the liquid crystal panel controller 62 is included on the driver D1 connected to the array substrate 22A; and the touch panel controller 60 is included on the driver (not shown) mounted on the second flexible substrate 23B. There are connections between the controller 50 and the touch panel controller 60; the controller 50 and the liquid crystal panel controller 62; and the controller 50 and the motor controller 64. The touch panel 24 and the touch panel controller 60 are one example of a touch detection unit.

As shown in FIG. 7, the controller 50 is constituted by a CPU 52, ROM 54, RAM 56, and the like. The CPU 52 controls the input device 10 by executing various types of programs stored in the ROM 54 in accordance with operation instructions from the user. The ROM 54 stores programs, data, and the like to be executed by the CPU 52. The RAM 54 is used as a temporary storage area when the CPU 52 is executing various types of processes. The CPU 52 and the liquid crystal panel controller 62 are one example of an input controller, and the CPU 52 and motor controller 64 are one example of a vibration controller.

The touch panel controller 60 detects the position on the display screen 20A touched by the user. In the touch panel 24, if the finger of the user, which is a conductor, approaches or contacts the display screen 20A while a voltage is being sequentially applied to the plurality of first transmissive electrode 25A columns and plurality of second transmissive electrode 25B columns, then the finger of the user will capacitively couple with one of the transmissive electrodes 25A and 25B, and the electrostatic capacitance value of this transmissive electrode 25A and 25B will differ from the electrostatic capacitance value of the other transmissive electrodes 25A and 25B. A coordinate plane is defined on the display screen 20A, and the touch panel controller 60 detects the transmissive electrodes 25A and 25B where the difference in electrostatic capacitance has occurred and converts the coordinates on the display screen 20A corresponding to an intersection of the transmissive electrodes 25A and 25B into two-dimensional (X-axis direction and Y-axis direction) location information signals relating to the location on the display screen 20A that has been touched by the user, and then outputs this signal to the CPU 52.

The liquid crystal panel controller 62 outputs display control signals to the liquid crystal panel 22 in accordance with the control signals output from the CPU 52, and then controls the display contents that are displayed on the display screen 20A. Specifically, the display control signals from the liquid crystal panel controller 62 control driving of the TFTs on the liquid crystal panel 22 to selectively control the transmittance of light through the liquid crystal panel 22, thereby displaying a prescribed image on the display screen 20A.

The motor controller 64 outputs vibration control signals to the vibration unit 32 in accordance with the control signals output from the CPU 52 and controls driving of the vibration motor of the vibration unit 32 in order to control the vibration unit 32. The vibration unit 32 is switched between OFF and ON by the vibration control signals from the motor controller 64. Immediately after the power of the input device 10 has been turned ON, the vibration unit 32 turns OFF.

(Display Control Process)

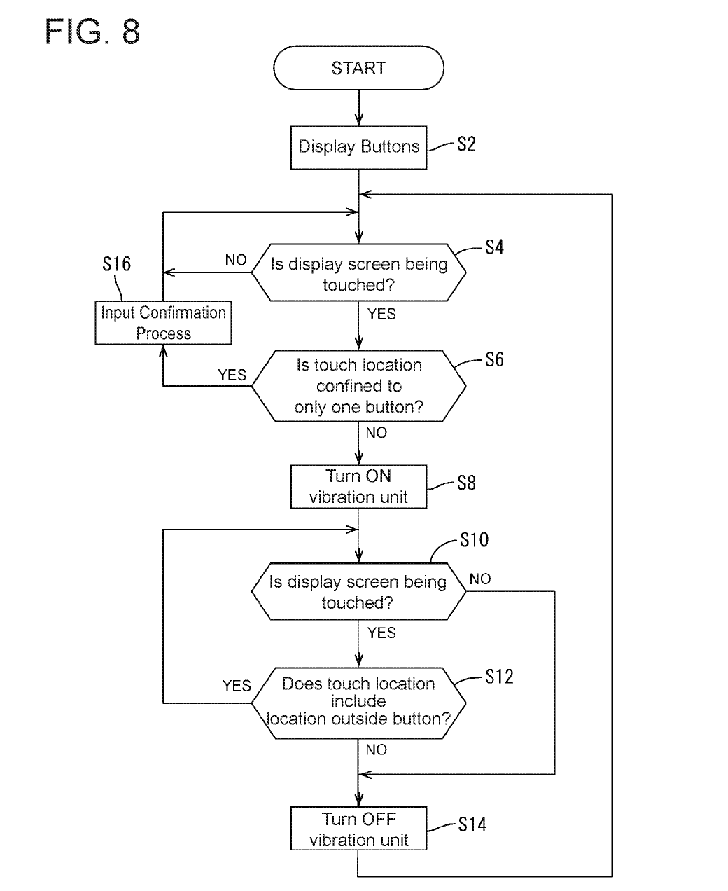

Next, the vibration control process performed by the CPU 52 in the input device 10 will be described with reference to the flow chart shown in FIG. 8. The vibration control process of the present embodiment is performed by the CPU 52 after the input device 10 turns ON in accordance with a program stored in the ROM 54. Specifically, the vibration control process is when the CPU 52 switches the vibration unit 32 OFF and ON via the controller 64 in accordance with the location on the display screen 20A that has been touched by the user.

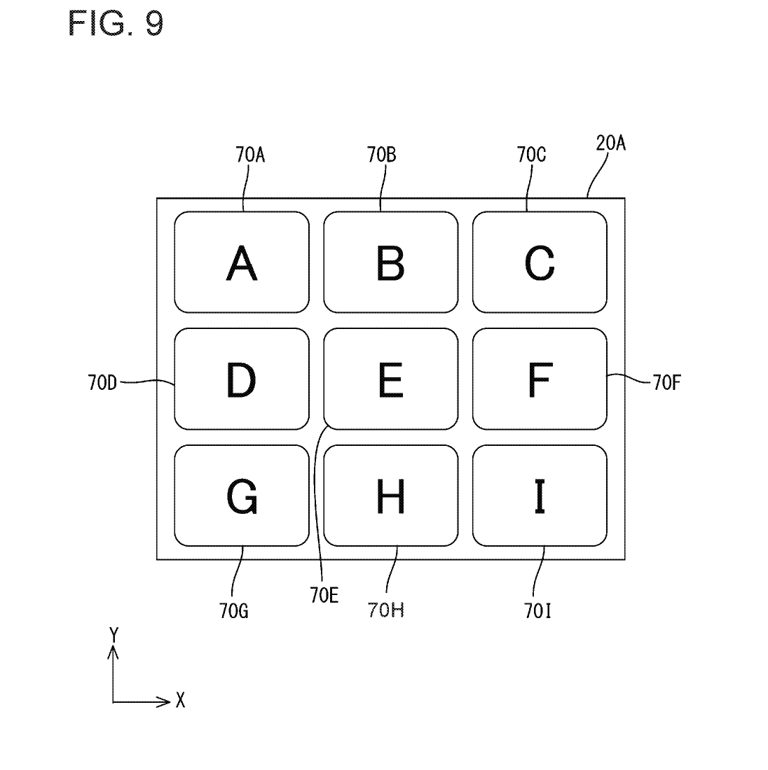

First, a display aspect of the display screen 20A of the present embodiment will be described with reference to FIG. 9. As shown in FIG. 9, there are nine buttons (one example of valid regions) 70A to 70I equal in shape and size being displayed on the display screen 20A in accordance with the display control signals from the liquid crystal panel controller 62. The buttons 70A to 70I are displayed with three buttons to one row in the horizontal direction (X-axis direction) and three to one row in the vertical direction (Y-axis direction) in a matrix shape with prescribed gaps therebetween. A coordinate plane is defined on the display screen 20A, and the CPU 52 determines which location on the image displayed on the display screen 20A has been touched by comparing the location in the location information output from the touch panel controller 60 to the location on the coordinate plane defined on the display screen 20A.

The vibration control process will now be explained. As shown in FIG. 8, when the user turns the input device 10 ON, the CPU 52 causes a plurality of buttons 70A to 70I to be displayed on the display screen 20A in the display aspect described above (S2). Next, the CPU 52 determines whether the user is touching the display screen 20A (S4). Specifically, the CPU 52 determines whether a location information signal having a touched location is being output from the touch panel controller 60 due to the user touching a location on the display screen 20A.

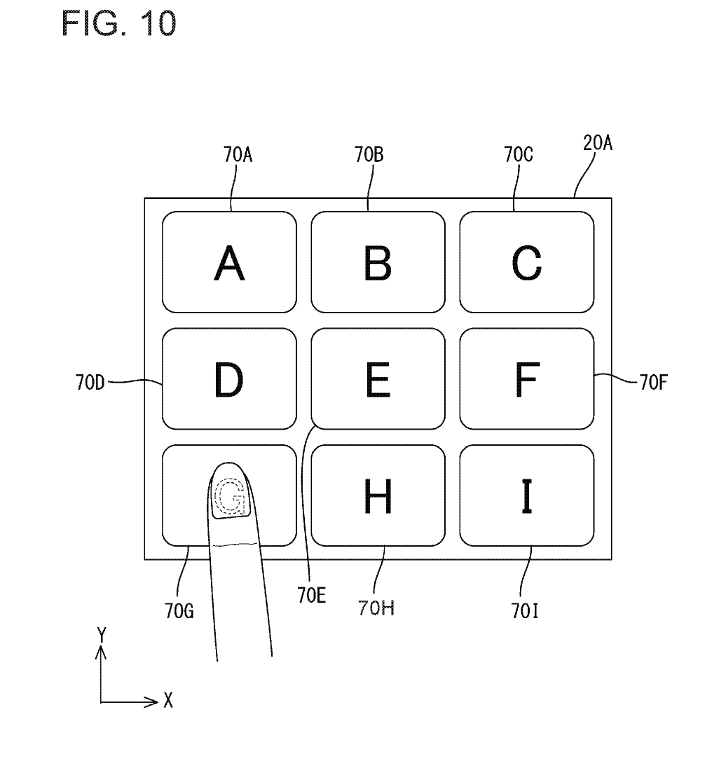

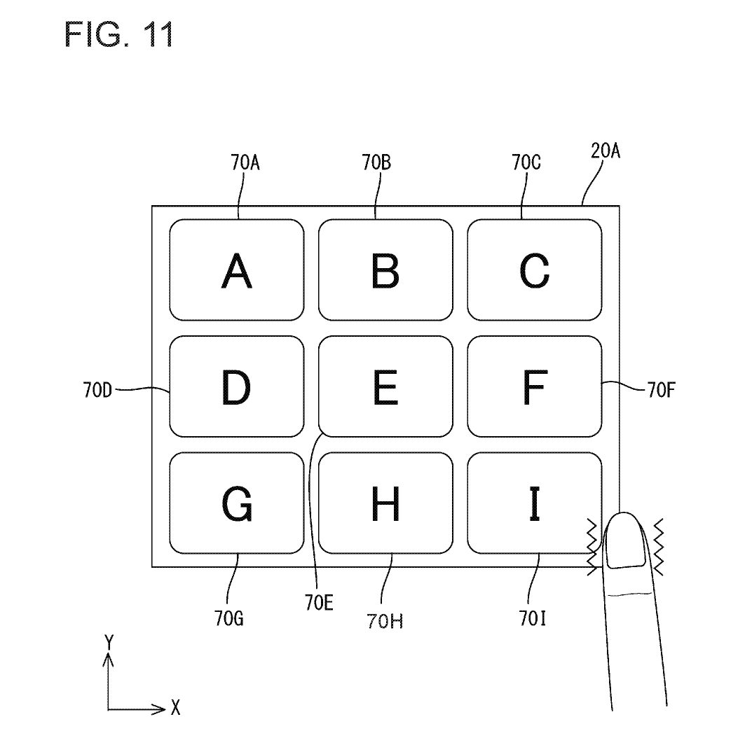

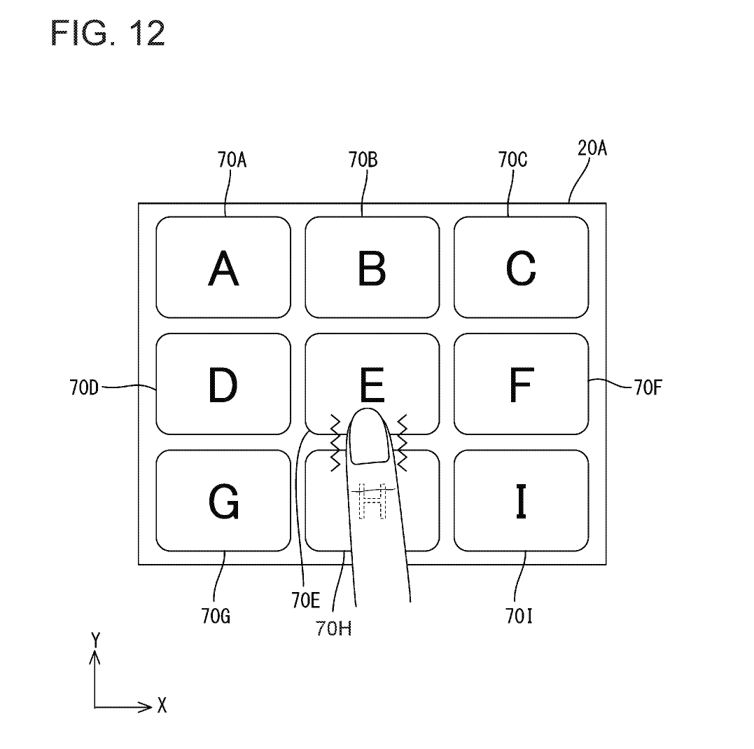

If the CPU 52 determines that the user is not touching the display screen 20A (NO in S4), then the CPU 52 repeatedly executes the process in S4. If the CPU 52 determines that the user is touching the display screen 20A (YES in S4), then the CPU 52 determines if the location on the display screen 20A touched by the user fits within only one button (S6). Specifically, the CPU 52 determines if the location in the location information output from the touch panel controller 60 is a location that fits within only one button among the nine buttons 70A to 70I displayed on the display screen 20A. In the present specification, the “location that fits within only one button” means the location within the outline surrounding each button 70A to 70I and does not include the location straddling the inside of each button 70A to 70I and outside of each button 70A to 70I. Accordingly, a state in which the location on the display screen 20A touched by the user fits within only one button refers to a state such as that shown in FIG. 10, for example, and does not include states such as those shown in FIGS. 11 and 12.

If the CPU 52 determines that the location on the display screen 20A touched by the user fits within only one button (YES in S6), then the CPU 52 performs an input confirmation process (described later). If the CPU 52 determines that the location on the display screen 20A touched by the user does not fit within only one button (NO in S6), then the CPU 52 turns ON the vibration unit 32 via the motor controller 64 (S8).

If the vibration unit 32 is turned ON in S8, the CPU 52 determines whether the user is touching the display screen 20A, similar to the process performed in S4 (S10). The CPU 52 performs a process similar to S4 again because it is conceivable that the user, after touching the display screen 20A, removes the finger used to touch from the display screen 20A, or the like.

If the CPU 52 determines that the user is touching the display screen 20A (YES in S10), then the CPU 52 determines whether the location on the display screen 20A touched by the user includes a location outside the button (S12). The CPU 52 determines the location on the display screen 20A touched by the user again because it is conceivable that the location on the display screen 20A touched by the user has changed due to the user moving the finger used for touching. In S12, specifically, the CPU 52 determines that a location outside the button is included if the location in the location information output from the touch panel controller 60 is a location outside each button 70A to 70I displayed on the display screen 20A, a location straddling the inside of the buttons 70A to 70I and the outside of the buttons 70A to 70I, or the like. In other words, a state in which the location on the display screen 20A touched by the user includes a location outside the button refers to states such as those shown in FIGS. 11 and 12, for example, and does not include a state such as that shown in FIG. 10.

If the CPU 52 determines that a location on the display screen 20A touched by the user includes a location outside the button (YES in S12), the CPU 52 returns to step S10 and again determines whether the user is touching the display screen 20A. At such time, the vibration unit 32 is ON, and is thus continually vibrating. On the other hand, if the CPU 52 determines that the location on the display screen 20A touched by the user does not include a location outside the button (NO in S12), then the CPU 52 turns OFF the vibration unit 32 via the motor controller 64 (S14). When the vibration unit 32 is turned OFF in S14, the CPU 52 returns to S4.

Next, a simple explanation will be provided for an input confirmation process executed by the CPU 52 in S16. The input confirmation process confirms that the input from the touch is valid in a case in which the location on the display screen 20A touched by the user fits within only one button. In the present embodiment, after the CPU 52 determines that the location on the display screen 20A touched by the user in S6 fits within only one button, if the CPU 52 determines that the same location that fits within only one button has been consecutively touched within a prescribed period time (double tapped), then the input from this touch is confirmed to be valid and the function associated with the button is instructed to be performed. After finishing the input confirmation process, the CPU 52 returns to S4.

(Vibration Aspect of Input Device)

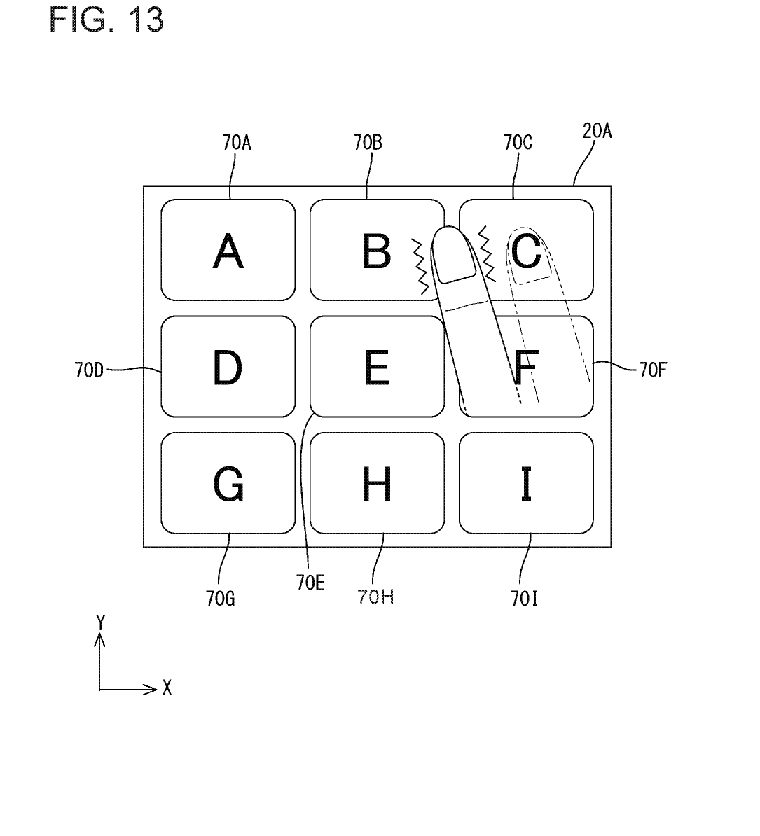

A vibration control process performed by the CPU 52 was described above, and next two touch examples will be used to describe a vibration aspect of the input device 10 following the vibration control process of the present embodiment. In these examples, the input device 10 is used as a car-mounted navigation system, and the user is performing touch operation on the display screen 20A without looking at the display screen 20A. In FIGS. 13 to 16, the top of the drawing is the top of the display screen 20A, and the right side of the drawing is the right side of the display screen 20A. In the first touch example, as shown in FIG. 13, a scenario will be described in which the user attempts to touch the C button 70C on the display screen 20A but instead accidentally touches the region between the C button 70C and the B button 70B. In such a scenario, the CPU 52 determines that the display screen 20A is being touched (YES in S4), and determines that the location on the display screen 20A touched by the user does not fit within only one button (NO in S6). As a result, the vibration unit 32 turns ON (S8).

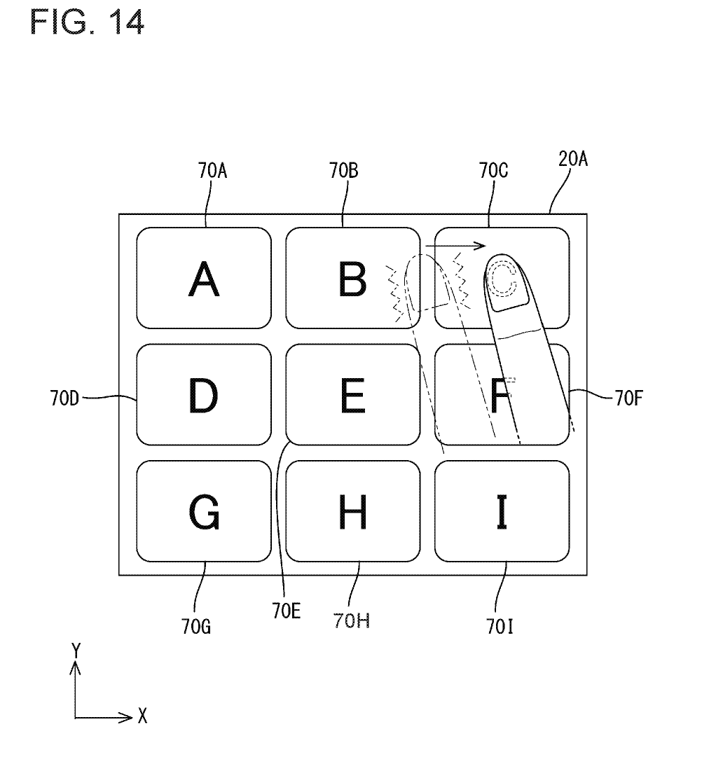

The user senses the vibration of the display unit 20 due to the vibration unit 32 being turned ON, and is thus able to know that the location on the display screen 20A that has been touched is wrong. At this point, the user can shift the touch location in accordance with the pre-stored arrangement of the buttons 70A to 70I. While the user is shifting the touch location, the CPU 52 determines that the user is touching the display screen 20A (YES in S10). Furthermore, while the user is shifting the touch location, the vibration unit 32 is ON, and thus the display unit 20 is continuing to vibrate. If the user shifts the touch location to the right to a position that fits within only the C button 70C (the state shown in FIG. 14), then the CPU 52 determines that the location on the display screen 20A touched by the user fits within only one button (NO in S12) and turns the vibration unit 32 OFF. This stops the vibration of the display unit 20; therefore, the user can know that the touch location fits within only the desired C button 70C. Thereafter, the user can double tap the same location to cause the input device 10 to perform the function associated with the C button 70C.

The CPU 52 performing the vibration control process in this manner turns ON the vibration unit 32 while the user is touching a location on the display screen 20A that includes a location outside the button and continually vibrates the display unit 20, and when the user touches a location on the display screen 20A that fits within only one button or the display screen 20A stops being touched (if the finger doing the touching is removed from the display screen 20A), then the vibration unit 32 turns OFF and the display unit 20 stops vibrating. Therefore, the user can shift the touch location in accordance with the pre-stored arrangement of the buttons 70A to 70I while sensing whether or not the display unit 20 is vibrating, thereby allowing the user to touch a location that fits within only the desired button 70C.

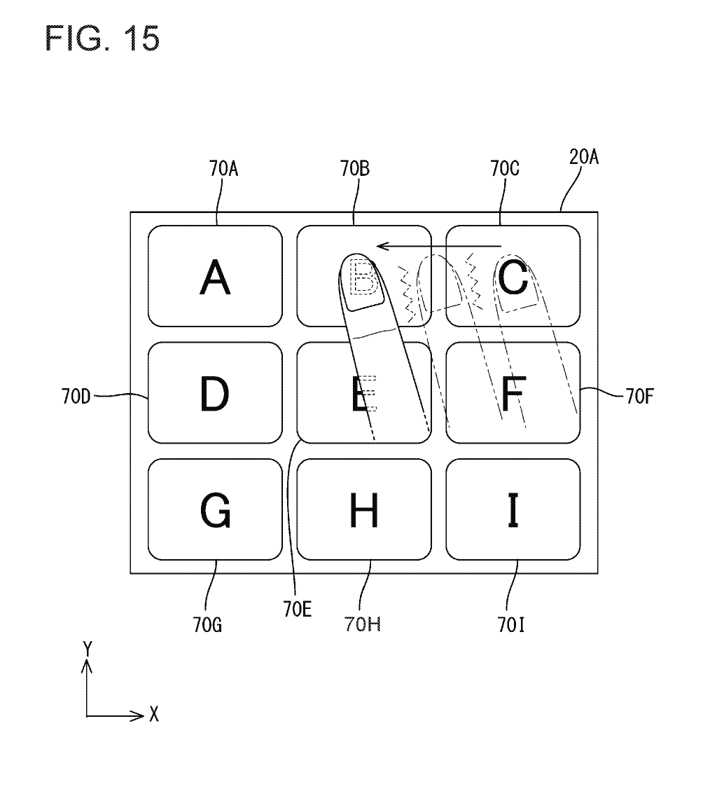

Next, the second touch example will be described. In this example, the user touches a location that fits within only the C button 70C, and then shifts the touch location to a location that fits within the E button 70E in accordance with the pre-stored arrangement of the buttons 70A to 70I. First, when the user has touched the location that fits only within the C button 70C, the vibration unit 32 is OFF. Then, when the user shifts the touch location to the left in accordance with the pre-stored arrangement of the buttons 70A to 70I and the touch location becomes the region between the C button 70C and the B button 70B, the vibration unit 32 turns ON and the display unit 20 vibrates. This allows the user to know that the touch location includes a location outside the C button 70C. As shown in FIG. 15, as the user continues to shift the touch location to the left, and the touch location becomes a location that fits within only the B button 70B, the vibration unit 32 turns OFF again and the display unit 20 stops vibrating. This allows the user to know that the touch location is a location that fits within only the B button 70B.

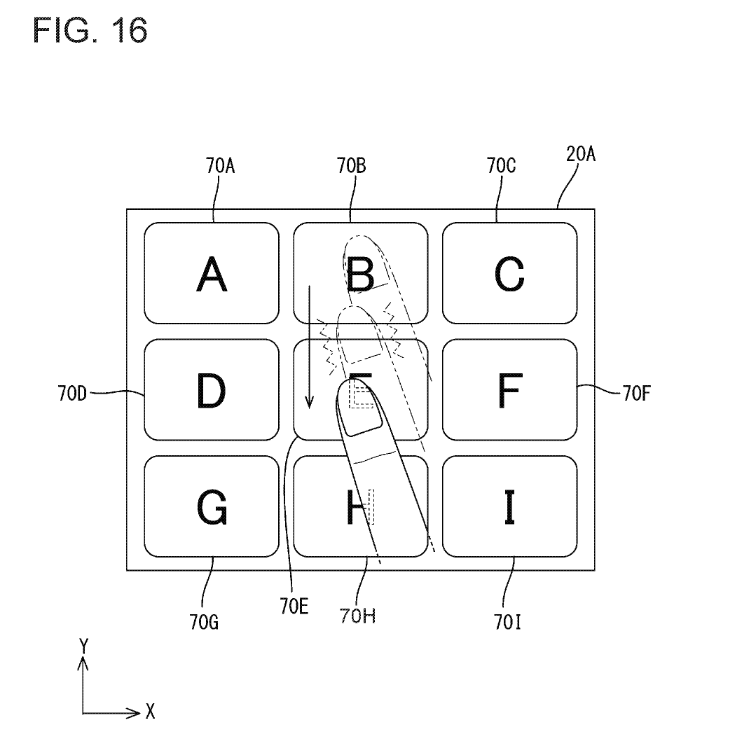

Next, if the user shifts the touch location downwards in accordance with the pre-stored arrangement of the buttons 70A to 70I and the touch location becomes the region between the B button 70B and the E button 70E, the vibration unit 32 turns ON again and the display unit 20 vibrates. This allows the user to know that the touch location is a location that includes the B button 70B. As shown in FIG. 16, as the user continues to shift the touch location downwards, and the touch location becomes a location that fits within only the E button 70E, the vibration unit 32 turns OFF again and the display unit 20 stops vibrating. This allows the user to know that the touch location is a location that fits within only the B button 70B. Thereafter, the user can double tap the same location to cause the input device 10 to perform the function associated with the E button 70E.

### Effects of Embodiments

In the present embodiment, if the touch location of the user does not fit within only one button, then it is unclear which button the user desires to touch, and thus improper to judge such a location as an appropriate location for the touch location of the user. In the input device 10 of the present embodiment as described above, if the touch location of the user fits within only one button, the display unit 20 does not vibrate, and if the touch location includes a location outside the button, the vibration unit 32 continually vibrates the display unit 20 while such a location is being detected (while the location is being touched); therefore, the user is able to recognize that the location fits within only one button by shifting the touch location until the vibration stops.

Accordingly, in the input device 10 of the present embodiment, even if the display screen 20A does not have recesses, protrusions, or the like for indicating the location of the buttons 70A to 70I, or namely, even if the display screen 20A is a flat surface, the user can arrive at the desired button by shifting the touch location in accordance with the pre-stored arrangement of the buttons 70A to 70I. In this manner, in the input device 10 of the present embodiment, a simple configuration that does not require processing or the like of the display screen 20A makes it possible to guide the user to the desired button on the display screen 20A when it is unclear whether the touch location of the user on the display screen 20A is an appropriate location.

Furthermore, in the present embodiment, the nine buttons 70A to 70I displayed on the display screen 20A are equal in size and shape and displayed in a matrix on the display screen 20A. This type of display aspect allows the user to shift the touch location on the display screen 20A in either the vertical or horizontal direction on the display screen 20A in order to arrive at the desired button. Thus, in the present embodiment, it is possible to easily guide the user to the desired button on the display screen 20A as compared to if the size, shape, etc. of the buttons 70A to 70I differed from each other or if the buttons 70A to 70I were displayed in an irregular arrangement.

Moreover, in the present embodiment, the display unit 20 continually vibrates while the touch location on the display screen 20A includes a location outside the button; therefore, the user can arrive at the desired button by shifting the touch location in accordance with the arrangement of the pre-stored buttons 70A to 70I until the display unit 20 stops vibrating, even if the user cannot see the display screen 20A. Thus, the input device 10 of the present embodiment is suitable for devices where the display screen 20A is touched by the user without being looked at, such as car-navigation systems.

If the vibration unit were vibrated when the touch location on the display screen is appropriate, or namely, when the touch location fits within only one button, it is possible that people would find it unpleasant for the display unit to be vibrating despite being an appropriate touch location. In particular, for someone used to operations of an input device via continued operation thereof, who more often touches appropriate locations than wrong locations, this type of scenario would be markedly more unpleasant. As a countermeasure, in the present embodiment, the vibration unit 32 does not vibrate when the touch location is appropriate, and thus is not susceptible to causing this type of unpleasantness.

### Embodiment 2

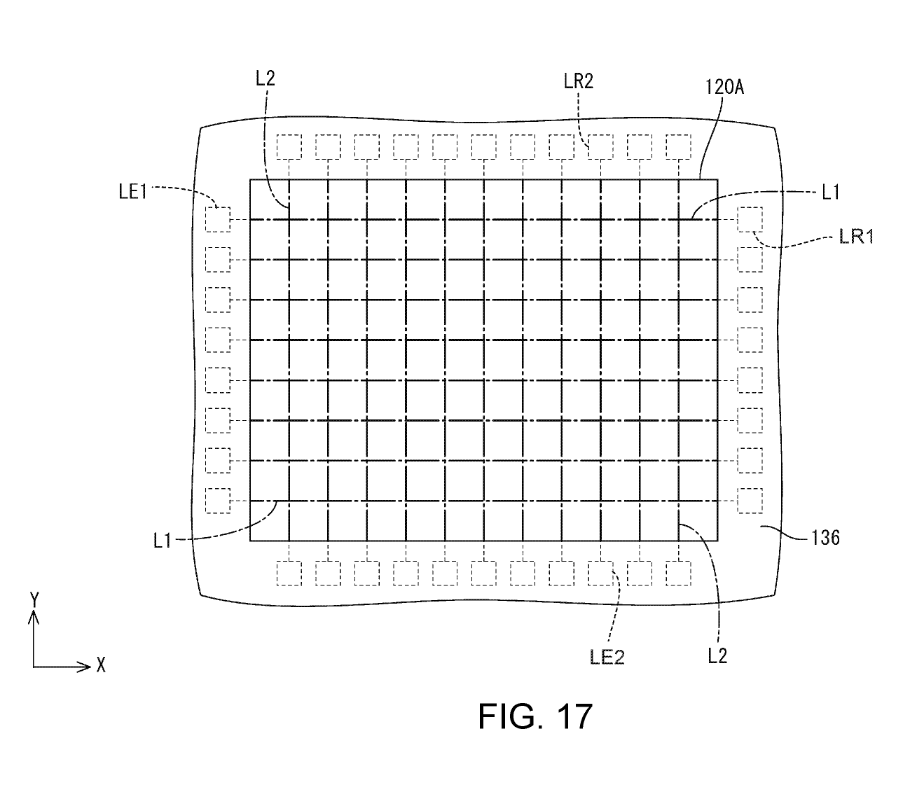

Embodiment 2 will be described with reference to FIGS. 17 to 22. Embodiment 2 differs from Embodiment 1 in part of the method of detecting touch location, the display aspect of the display screen, and the vibration control process. Other configurations are similar to those of Embodiment 1; thus, the descriptions of the configurations, operation, and effects are omitted. In FIG. 17 and FIGS. 19 to 22, the top of the drawing is the top of a display screen 120A, and the right side of the drawing is the right side of the display screen 120A.

First, a method of detecting touch location on the touch panel of the input device of the present embodiment will be described with reference to FIG. 17. The touch panel of the present embodiment is a so-called infrared ray scanning scheme in which light emitters and light receivers are disposed facing each other in the vertical direction and horizontal direction surrounding the surface of the display screen 120A, and the areas where light is blocked are detected as touch locations.

(Method of Detecting Touch Location)

As shown in FIG. 17, in the present embodiment, around the surface of the display screen 120A are arranged first LED (light emitting diode) light emitters LE1 & second LED light emitters LE2 and first LED receivers LR1 & second LED receivers LR2, which receive infrared light. The first LED emitters LE1 are arranged in a plurality along the vertical direction (Y-axis direction) of the display screen 120A in the region on the left side of the display screen 120A and emit infrared rays towards the right along the horizontal direction (X-axis direction) of the display screen 120A. The first LED receivers LR1 are arranged in a plurality along the vertical direction of the display screen 120A in the region on the right side of the display screen 120A so as to face the respective first LED emitters LE1 and receive the infrared rays emitted from the respective first LED emitters LE1. The second LED emitters LE2 are arranged in a plurality along the horizontal direction (X-axis direction) of the display screen 120A in the region on the bottom side of the display screen 120A and emit infrared rays towards the top along the vertical direction (Y-axis direction) of the display screen 120A. The second LED receivers LR2 are arranged in a plurality along the horizontal direction of the display screen 120A in the region on the top side of the display screen 120A so as to face the respective second LED emitters LE2 and receive the infrared rays emitted from the respective second LED emitters LE2. The respective LED emitters LE1 & LE2 and respective LED emitters LR1 & LR2 are covered by a bezel 136 and hidden from the outside of the input device.

With this configuration, when infrared rays are emitted from the respective LED emitters LR1 & LR2, the infrared rays are scanned in a grid pattern on the surface of the display screen 120A. In the touch panel of the present embodiment, if a finger of the user contacts or approaches the display screen 20A while the infrared rays are being emitted from the respective LED emitters LR1 & LR2, then some of the infrared rays emitted from the respective first LED emitters LE1 will be blocked by the finger of the user and some of the infrared rays emitted from the respective second LED emitters LE2 will also be blocked by the finger of the user. A coordinate plane is defined on the display screen 120A, and the touch panel controller of the present embodiment detects the first LED emitters LE1 and second LED emitters LE2 for which the infrared rays have been blocked and converts the coordinates on the display screen 120A corresponding to an intersection of the detected infrared rays emitted from the first LED emitters LE1 and the infrared rays emitted from the second LED emitters LE2 into two-dimensional (X-axis direction and Y-axis direction) location information signals relating to the location on the display screen 120A that has been touched by the user, and then outputs this signal to the CPU. In the present embodiment, the location on the display screen 120A touched by the user can be detected in this manner.

(Vibration Control Process)

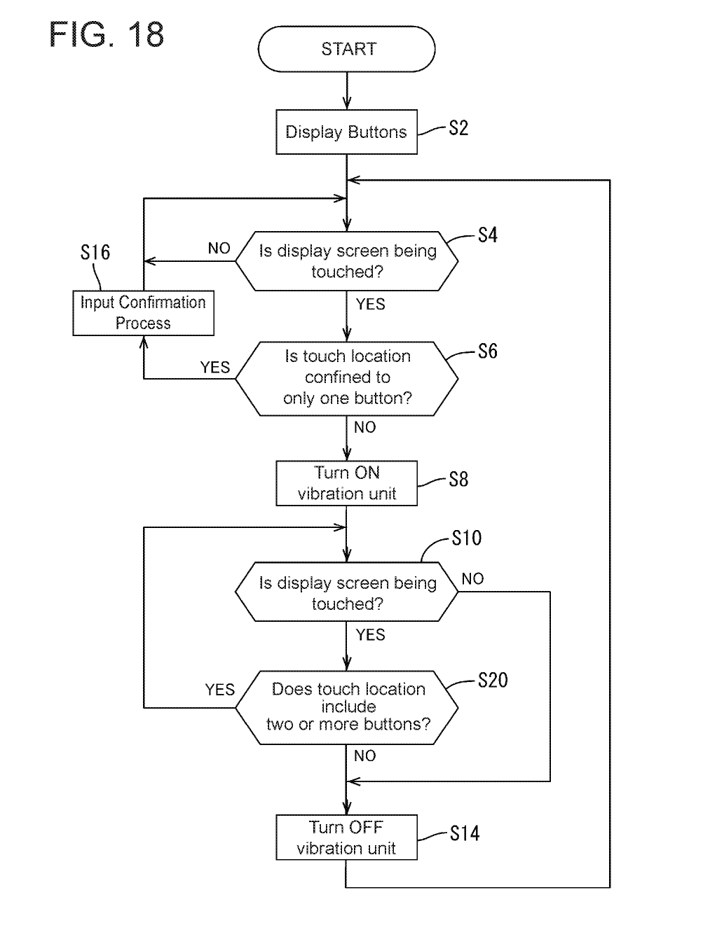

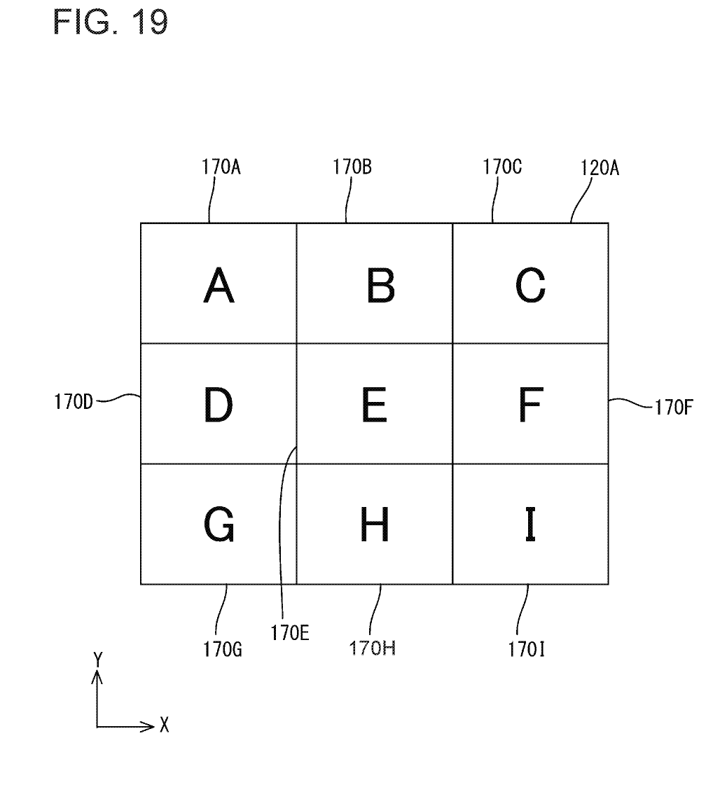

Next, a vibration control process performed by a CPU in the input device of the present embodiment will be described with reference to the flowchart shown in FIG. 18. First, a display aspect of the display screen 120A of the present embodiment will be described with reference to FIG. 19. As shown in FIG. 19, in the present embodiment, nine buttons 170A to 170I having equal shape and size are displayed on the display screen 120A in accordance with the display control signals from the liquid crystal panel controller. In the present embodiment, the buttons are displayed over the entirely of the display screen 120A, and the buttons are displayed with three buttons to one row in the horizontal direction (X-axis direction) and three to one row in the vertical direction (Y-axis direction) in a matrix shape with each button abutting at least one other button. Accordingly, in the present embodiment, the location on the display screen 120A to be touched by the user is a location including at least one of the buttons 170A to 170I.

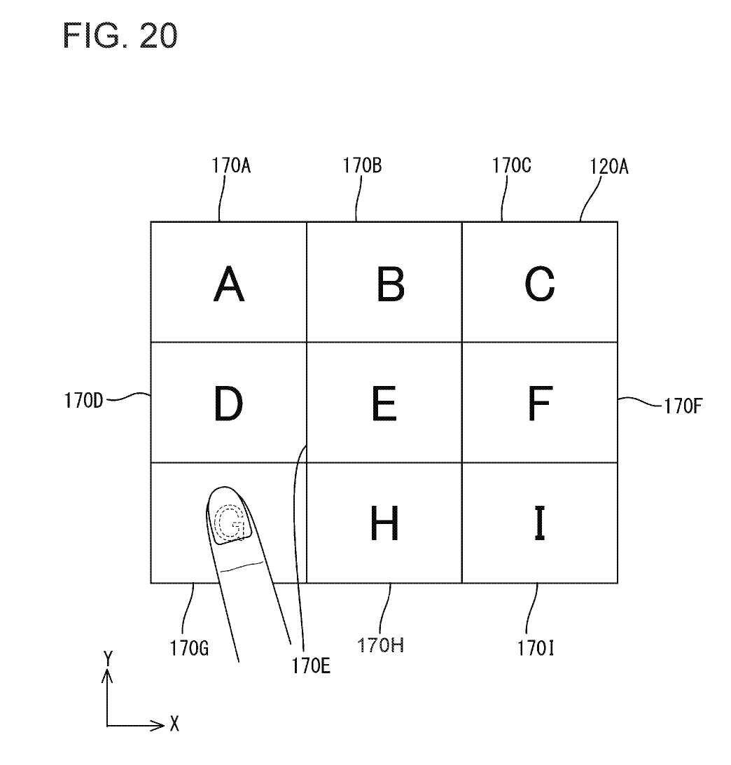

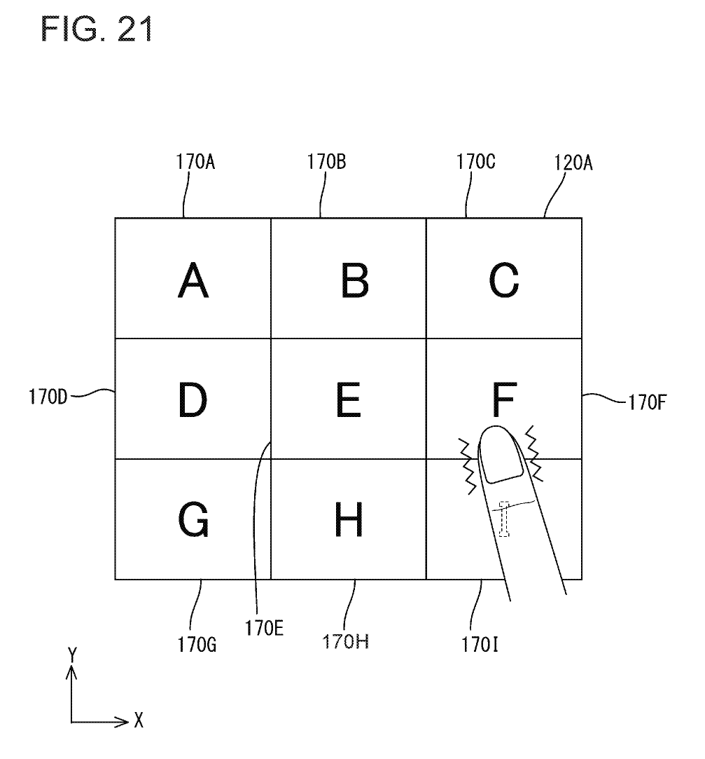

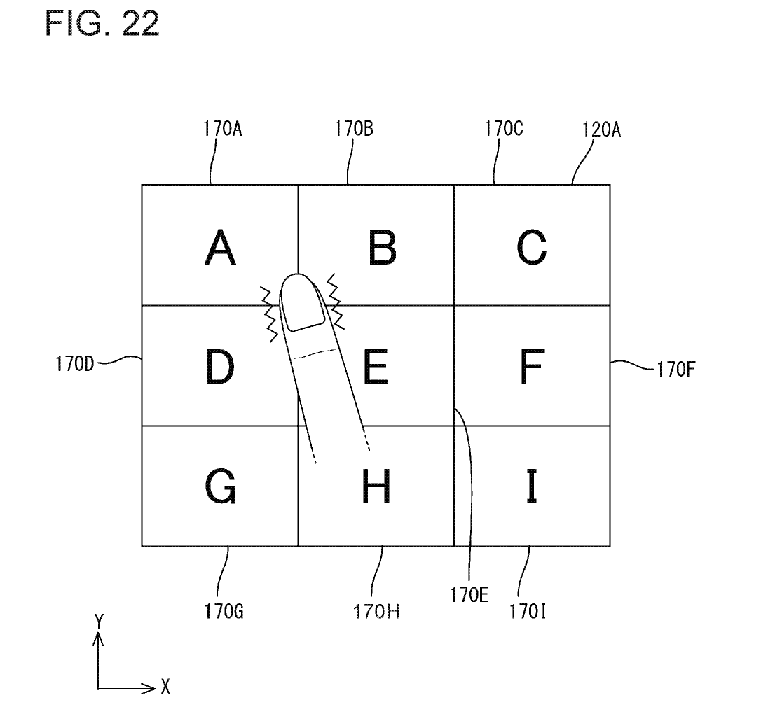

The vibration control process of the present embodiment will now be explained. The vibration control process of the present embodiment differs from the vibration control process of Embodiment 1 only in the process in S12. Therefore, processes that are the same as the vibration control process of Embodiment 1 will be omitted. In the vibration control process of the present embodiment, if the CPU 52 determines that the user is touching the display screen 120A in S10, then the CPU determines whether the location on the display screen 120A touched by the user includes two or more buttons (S20). Specifically, the CPU 52 determines that two or more buttons are included when the location in the location information output from the touch panel controller 60 is a location that straddles two or more buttons. In other words, a state in which the location on the display screen 120A that has been touched by the user includes two or more buttons refers to states such as those shown in FIGS. 21 and 22, for example, and does not include a state such as that shown in FIG. 20.

If the CPU determines that the location on the display screen 120A touched by the user includes two or more buttons (YES in S20), the CPU returns to S10 and again determines whether the user is touching the display screen 120A. At such time, the vibration unit is ON, and is thus continually vibrating. On the other hand, if the CPU determines that the location on the display screen 120A touched by the user does not include two or more buttons (NO in S20), then the CPU turns the vibration unit OFF via the motor controller (S14). After turning the vibration unit OFF in S14, the CPU returns to S4.

In the present embodiment as described above, each of the nine buttons 170A to 170I is displayed on the display screen and each button abuts at least one other button. Therefore, if the touch location of the user includes a location within two or more buttons, it is difficult to determine which button the user wants to touch. As a countermeasure, in the present embodiment, if the touch location of the user includes a location within two or more buttons, the display unit continually vibrates during the touching, and thus even if the nine buttons 170A to 170I are displayed abutting each other, the user can be guided to the desired button on the display screen 120A by shifting the touch location until the vibrating stops.

### Embodiment 3

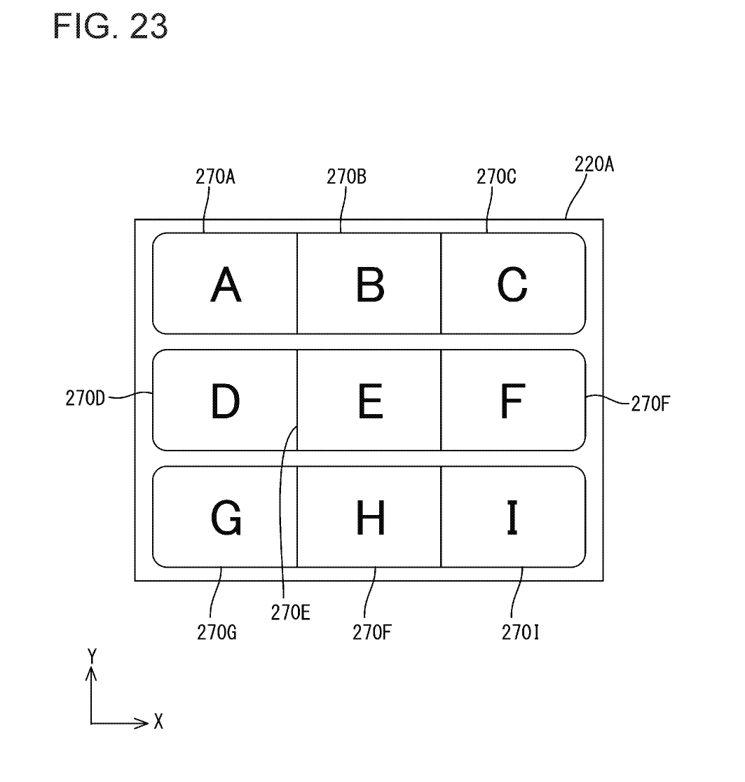

Embodiment 3 will be described with reference to FIG. 23. Embodiment 3 differs from Embodiment 1 and Embodiment 2 in the display aspect of the display screen 220A. Other configurations are similar to those of Embodiment 1; thus, the descriptions of the configurations, operation, and effects are omitted. In the present embodiment, as shown in FIG. 23, nine buttons 270A to 270I having equal shape and size are displayed on a display screen 220A in accordance with the display control signals from the liquid crystal panel controller. The buttons 270A to 270I are displayed with three buttons to one row in the horizontal direction (X-axis direction) and three to one row in the vertical direction (Y-axis direction), with the buttons abutting one another in the horizontal direction and being arranged in a matrix shape with prescribed gaps therebetween in the vertical direction.

In the present embodiment, by displaying the buttons 270A to 270I on the display screen 220A in the display aspect described above, the vibration unit will be caused to vibrate if the location on the display screen 220A touched by the user is a location outside the buttons 270A to 270I displayed on the display screen 220A; if the location straddles the inside of the buttons 270A to 270I and outside of the buttons 270A to 270I; if the location includes two or more buttons, or the like. This makes it possible to guide the user to the desired button on the display screen 220A when it is unclear whether the touch location of the user on the display screen 220A is an appropriate location.

Modification examples of the respective embodiments mentioned above are described below.

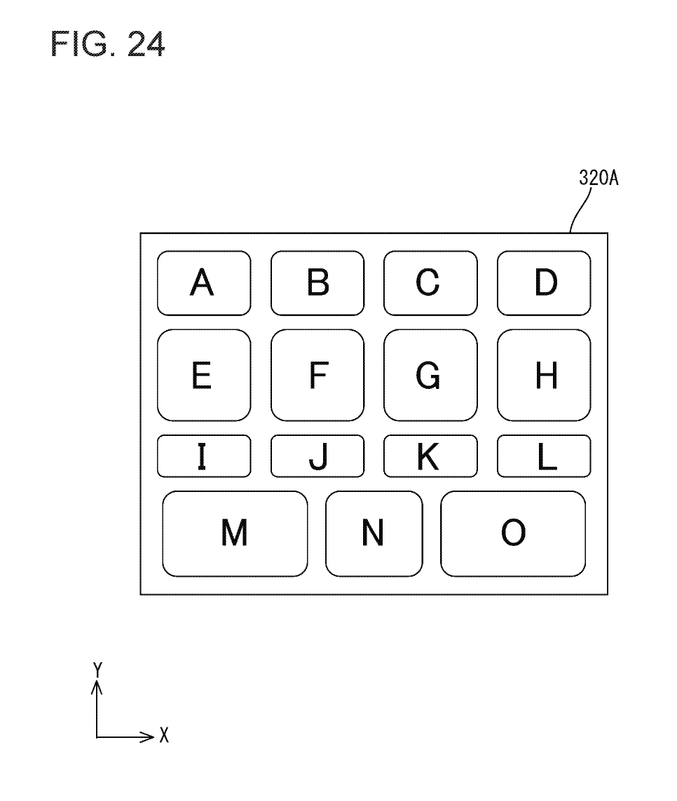

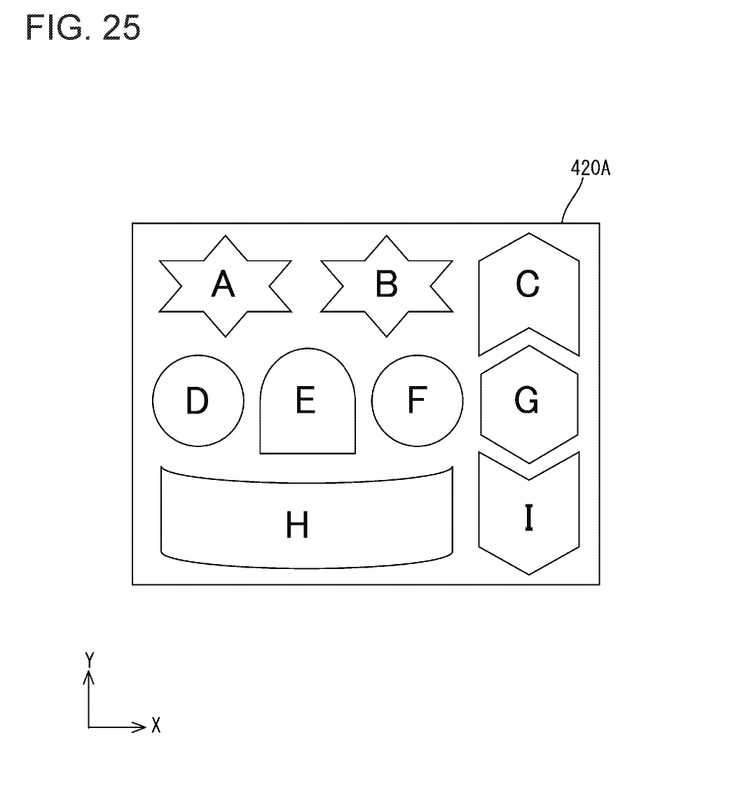

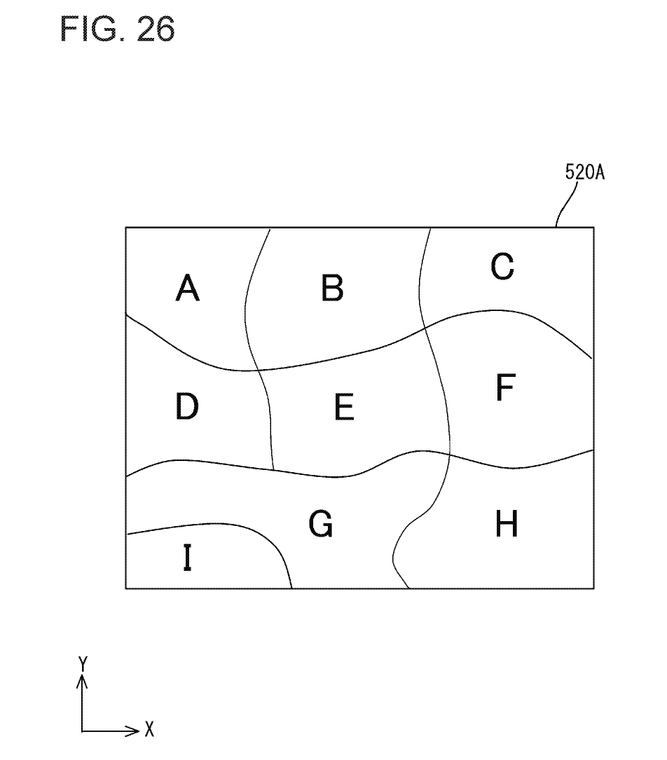

(1) In the respective embodiments above, an example was shown in which a plurality of buttons equal in size and shape are displayed as a matrix on the display screen, but the display aspect of the plurality of buttons displayed on the display screen is not limited to this. As shown in FIG. 24, for example, a plurality of buttons, from an A button to an O button, having differing sizes may be displayed on a display screen 320A, or as shown in FIG. 25, a plurality of buttons having an irregular arrangement and differing shapes and sizes may be displayed on a display screen 420A, or as shown in FIG. 26, a plurality of buttons having differing shapes and sizes may be displayed over the entirety of a display screen 520A with each button abutting at least one other button.

(2) In the respective embodiments above, an example was shown in which an electrostatic capacitance scheme and an infrared ray scanning scheme are described as methods of detecting touch location, but the method of detecting touch location is not limited to this. A pressure-sensitive scheme or the like in which changes in pressure occurring in the touch panel are used to detect touch location may be used instead, for example.

(3) In the respective embodiments above, an example was shown in which a vibration scheme of a vibration unit was used as the vibration motor, but the vibration scheme of the vibration unit is not limited to this. A piezoelectric vibration motor that uses piezoelectric element may be used instead, for example, or a linear actuator, or a configuration using a different vibration scheme. Basically, any configuration may be used as long as the configuration can convert electrical energy into vibration energy.

(4) In the respective embodiments above, in the input confirmation process, an example was shown in which an input based on touch was confirmed to be valid by double tapping the same location fitting within only one button within a prescribed period of time, but the input confirmation process is not limited to this. For example, input based on touch may be confirmed as valid by strongly pressing a location that fits within only one button and detecting the widening area of the finger, or input based on touch may be confirmed as valid by strongly pressing the location that fits within only one button such that the deflection of the display screen caused by the pressing pressure is detected as changes in the electrostatic capacitance values in the transmissive electrodes or detected by a pressure sensor or the like.

(5) In the respective embodiments above, an example was shown using a so-called “out-cell” touch panel configuration in which the touch panel is adhered to the outside of the liquid crystal panel, but the configuration of the touch panel is not limited to this. For example, an on-cell configuration may be used in which the touch panel is integrated with the liquid crystal panel by being interposed between the CF substrate and the polarizing plate of the liquid crystal panel or an on-cell configuration may be used in which the touch panel is integrated with the liquid crystal panel by the touch panel function being embedded within the pixels of the liquid crystal panel.

(6) In the respective embodiments above, an example was shown in which an image is displayed on a display screen by the liquid crystal panel and the backlight device, but the configuration for causing an image to be displayed on the display screen is not limited to this. For example, organic EL (electroluminescent) elements may be used to cause the image to be displayed on the display screen, or another scheme may be used to cause the image to be displayed on the display screen.

(7) In the respective embodiments above, an example was shown in which the input device is used as a car-mounted navigation system, but the input device of the present embodiment is not limited to this and can have various uses.

The embodiments of the present invention were described above in detail, but these are only examples, and do not limit the scope as defined by the claims. The technical scope defined by the claims includes various modifications of the specific examples described above.

### DESCRIPTION OF REFERENCE CHARACTERS

10 input device
20 display unit
20A, 120A, 220A, 320A, 420A, 520A display screen
22 liquid crystal panel
22A array substrate
22B CF substrate
24 touch panel
24A glass substrate
30 cover panel
32 vibration unit
34 backlight device
36, 136 bezel
38 case
50 controller
52 CPU
60 touch panel controller
62 liquid crystal panel controller
64 motor controller
70A to 70I, 170A to 170I, 270A to 270I button

1. An input device, comprising:
a display unit having a display screen on which a plurality of input regions are displayed and a touch detection unit that detects a touch on the display screen by a user;
a vibration unit that vibrates the display unit; and
a processor connected to the display unit and the vibration unit, configured to:
determine whether the touch detected by the touch detection unit occurs in one of the input regions and whether the touch is confined within said one of the input regions;
upon determining that the touch detected by the touch detection unit occurs in one of the input regions and that the touch is confined within said one of the input regions, recognize the touch as a valid input operation, and process an operation corresponding to said one of the input regions; and
upon determining that the touch detected by the touch detection unit does not occur in any one of the input regions or that the touch is not confined within any one of the input regions, recognize the touch as an invalid input operation, and instruct the vibration unit to vibrate and continue to vibrate the display unit while the touch is being detected unless and until said processor determines that the touch has been repositioned to one of the input regions and confined within said one of the input regions.

2-3. (canceled)

4. The input device according to claim 1,
wherein the plurality of input regions are equal in size and shape to one another, and are displayed on the display screen in a matrix pattern.
